(19) United States
(12) Patent Application Publication
(10) Pub. No.: US 2026/0064469 A1
(43) Pub. Date: Mar. 5, 2026

(54) ELECTRONIC DEVICE AND METHOD FOR MANAGING FLOATING-POINT UNIT RESOURCES

(71) Applicant: Sigmastar Technology Ltd., Xiamen (CN)

(72) Inventors: CHING-CHUAN YANG, Hsinchu County (TW); Shu Cheng Chou, Hsinchu County (TW); Cheng-Chi Huang, Hsinchu County (TW)

(21) Appl. No.: 19/314,014

(22) Filed: Aug. 29, 2025

(30) Foreign Application Priority Data
Aug. 29, 2024 (CN) 202411207674.9

(51) Int. Cl. G06F 9/50

(52) U.S. Cl. CPC G06F 9/5016

(57) ABSTRACT

A method for managing a floating-point unit (FPU) resource is applied to an electronic device. The electronic device includes a computing circuit and a memory. The memory stores a first variable and a second variable. The computing circuit includes an FPU. The FPU comprises an FPU register. The computing circuit operates in one of a first state, a second state, and a third state. The management method includes the following steps: (A) setting the first variable to point to an address of the second variable when the computing circuit switches from the first state to the second state, and the first variable is in an initial state; (B) filling the FPU register with an FPU context of the second variable; and (C) controlling the computing circuit to switch to the second state.

This application claims the benefit of China application Serial No. CN 202411207674.9 filed on August 29th, 2024, the subject matter of which is incorporated herein by reference.

### BACKGROUND OF THE INVENTION

### 1. Field of the Invention

The present invention generally relates to electronic devices, and more particularly, to the resource management of a floating-point unit (FPU).

### 2. Description of Related Art

FIG. 1 shows the hardware resources of a conventional electronic device. The conventional electronic device usually includes a central processing unit (CPU) and a memory (a volatile memory and/or a non-volatile memory). The CPU includes a floating-point unit (FPU) and multiple CPU registers (e.g., control registers, general-purpose registers, and state registers). The FPU is used for floating-point operations, and it includes multiple FPU registers. Therefore, as shown in FIG. 1, the hardware resources 100 of the electronic device include the CPU resource 110 (e.g., the content of the CPU registers), the memory resource 120 (e.g., the memory pointer), and the FPU resource 130 (e.g., the content of the FPU registers).

Modern operating systems can usually perform multitasking. During the process of switching tasks, the operating system must properly save the hardware resources 100 to maintain the correct operation of the electronic device. The saving of the hardware resources 100 is equally important for a multi-state CPU, especially when the multiple states correspond to different multi-systems. Otherwise, there may be data processing errors or even a system crash during the process of switching states.

### SUMMARY OF THE INVENTION

In view of the issues of the prior art, an object of the present invention is to provide an electronic device and a method of managing the FPU resources thereof, so as to make an improvement to the prior art.

According to one aspect of the present invention, an electronic device is provided. The electronic device includes: a computing circuit that includes a floating-point unit (FPU) comprising an FPU register and operates in one of a first state, a second state, and a third state; and a memory configured to store a first variable and a second variable. When the computing circuit switches from the first state to the second state, and the first variable is in an initial state, the computing circuit performs the following steps: (A) setting the first variable to point to an address of the second variable; and (B) filling the FPU register with an FPU resource content of the second variable.

According to another aspect of the present invention, a management method for a floating-point unit (FPU) resource is provided. The management method is applied to an electronic device including a computing circuit and a memory. The memory stores a first variable and a second variable. The computing circuit includes an FPU that comprises an FPU register. The computing circuit operates in one of a first state, a second state, and a third state. The management method includes the following steps: (A) setting the first variable to point to an address of the second variable when the computing circuit switches from the first state to the second state, and the first variable is in an initial state; (B) filling the FPU register with an FPU context of the second variable; and (C) controlling the computing circuit to switch to the second state.

According to still another aspect of the present invention, a management method for a floating-point unit (FPU) resource is provided. The management method is applied to an electronic device. The electronic device includes a computing circuit and a memory. The memory stores a first variable and a second variable. The computing circuit includes an FPU that includes an FPU register. The computing circuit operates in one of a first state, a second state, and a third state. The management method includes the following steps: (A) saving a content of the FPU register to a task control block (TCB) of a task pointed to by the first variable when the first variable is not in an initial state, and the first variable does not point to an address of the second variable. The task belongs to the first state, and the TCB is stored in the memory.

The technical means embodied in the embodiments of the present invention can solve at least one of the problems of the prior art. Therefore, compared to the prior art, the present invention can enhance the safety and stability of the system.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows the hardware resources of a conventional electronic device.

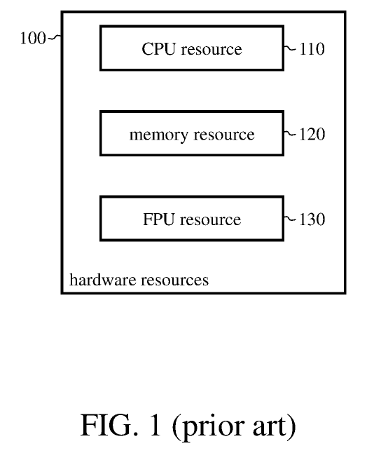

FIG. 2 is the functional block diagram of an electronic device according to an embodiment of the present invention.

FIG. 3 shows a task control block (TCB) for a task.

FIG. 4 is a schematic diagram of the computing circuit switching between multiple states according to the present invention.

FIG. 5 is a schematic diagram of the context switch according to the present invention.

FIG. 6 is a flowchart of task switch within a state according to an embodiment of the present invention.

FIG. 7 is a flowchart of the FPU resource management method according to an embodiment of the present invention.

FIG. 8 is a flowchart of the switching between states according to an embodiment of the present invention.

FIG. 9 is a flowchart of the FPU resource management method according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes an electronic device and a management method for a floating-point unit (FPU) resource. On account of that some or all elements of the electronic device could be known, the detail of such elements is omitted provided that such detail has little to do with the features of this disclosure, and that this omission nowhere dissatisfies the specification and enablement requirements. Some or all of the processes of the management method for an FPU resource may be implemented by software and/or firmware and can be performed by the electronic device or its equivalent. A person having ordinary skill in the art can choose components or steps equivalent to those described in this specification to carry out the present invention, which means that the scope of this invention is not limited to the embodiments in the specification.

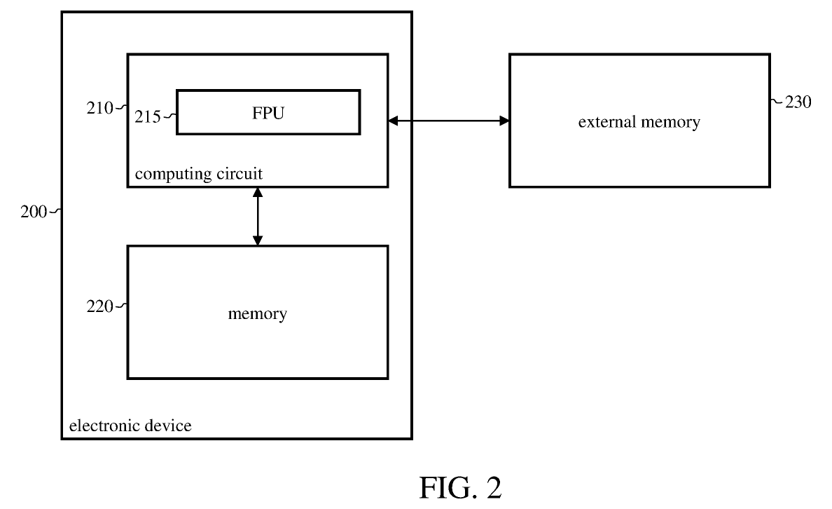

Reference is made to FIG. 2, which is a functional block diagram of the electronic device according to an embodiment of the present invention. The electronic device 200 includes a computing circuit 210 and a memory 220 (including, but not limited to, a volatile memory and/or a non-volatile memory) that are coupled to each other. The computing circuit 210 includes the FPU 215 and is further coupled to the external memory 230 (including, but not limited to, volatile memory and/or non-volatile memory). The memory 220 stores program codes and/or program instructions. The computing circuit 210 may be a circuit or electronic component with program execution capability, such as a CPU, a microprocessor, a micro-processing unit, a digital signal processor, an Application-Specific Integrated Circuit (ASIC), or an equivalent circuit. The computing circuit 210 executes the operating system and/or application programs of the electronic device 200 by executing the program codes and/or program instructions. In the following discussion, the computing circuit 210 is embodied using a CPU; this is for illustrative purposes only and does not limit the present invention.

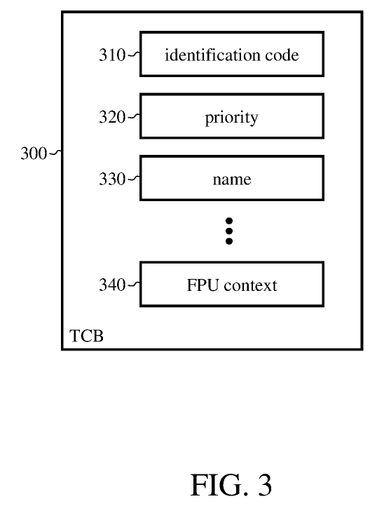

The computing circuit 210 can execute at least one operating system, and the computing circuit 210 can handle multiple tasks. FIG. 3 shows a task control block (TCB) for a task. The TCB 300 is a block of memory space (which, for example, may be a part of the memory 220) used to store the relevant state and information during task execution. The TCB 300 includes the identification code 310, the priority 320, the name 330, and the FPU context 340, among other information, of the task. The FPU context 340 is used to store the values of the registers of the FPU 215.

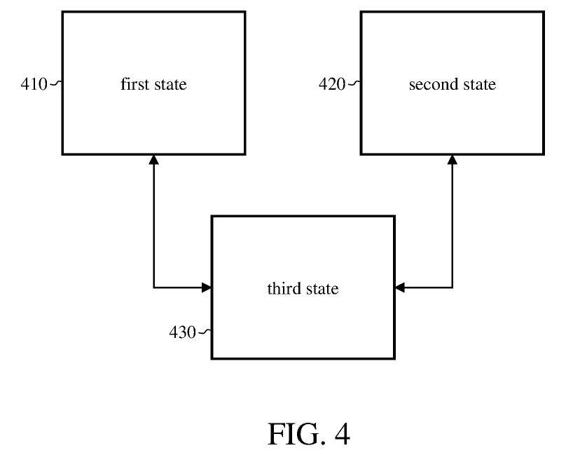

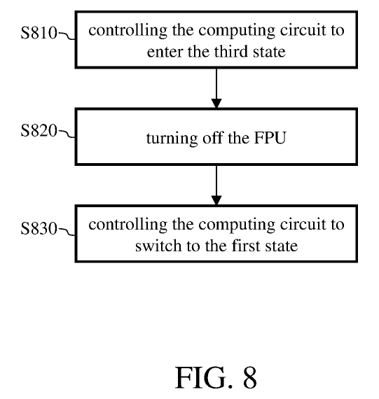

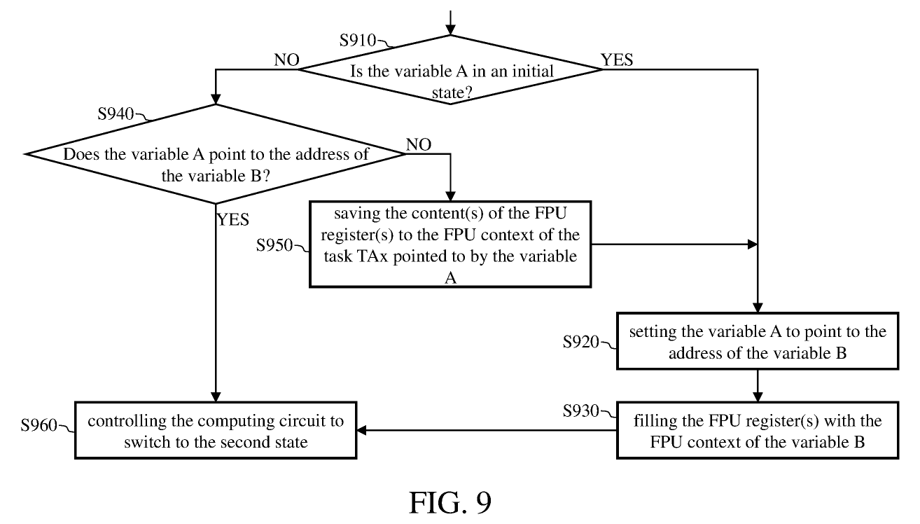

The computing circuit 210 can operate in multiple states to execute multiple systems. Reference is made to FIG. 4, which is a schematic diagram of the computing circuit switching between multiple states according to the present invention. The computing circuit 210 executes the first operating system in the first state 410, and executes the second operating system in the second state 420. When the computing circuit 210 is to switch from the first state 410 to the second state 420, or switch from the second state 420 to the first state 410, the computing circuit 210 first enters the third state 430. The third state 430 is a super high authority temporary state (also known as the monitor mode). The authority of the third state 430 is higher than the authority of the first state 410 and the authority of the second state 420. In the third state 430, the computing circuit 210 has the authority to switch states and performs a context switch (also known as an environment switch) between the operating systems (or states) by executing the monitor firmware (which will be detailed below with reference to FIG. 8 and FIG. 9). In some embodiments, the first state 410 is the security state, and the second state 420 is the non-security state, and the authority of the first state 410 is higher than the authority of the second state 420. In some embodiments, the first operating system is a simple operating system (simple OS), and the second operating system is a Rich OS.

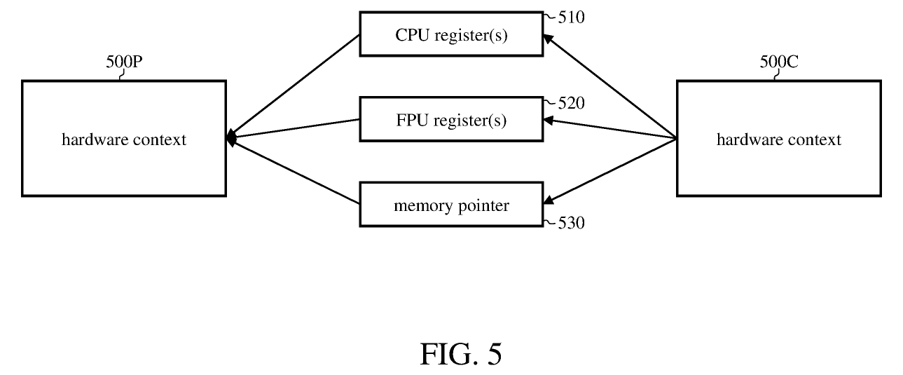

Reference is made to FIG. 5, which is a schematic diagram of the context switch according to the present invention. In the example of FIG. 5, the computing circuit 210 switches from the previous task TAp (corresponding to the hardware context 500P) to the current task TAc (corresponding to the hardware context 500C). More specifically, when performing a task switch, the operating system of the computing circuit 210 first saves the hardware resources used by the previous task TAp (including the contents of the CPU register(s) 510, the contents of the FPU register(s) 520, and the memory pointer 530) to the hardware context 500P of the previous task TAp, and then restores the hardware context 500C of the current task TAc (i.e., stores the hardware context 500C to the CPU register(s) 510, the FPU register(s) 520, and the memory pointer 530). Next, the computing circuit 210 can execute the current task TAc. The FPU register(s) 520 is/are included in the FPU 215. In some embodiments, the content(s) of the FPU register(s) 520 is/are saved to the TCB 300 of a previous task TAp (more specifically, saved to the FPU context 340).

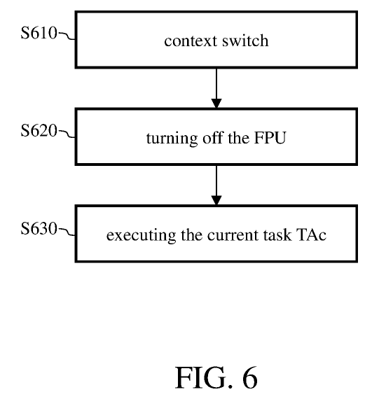

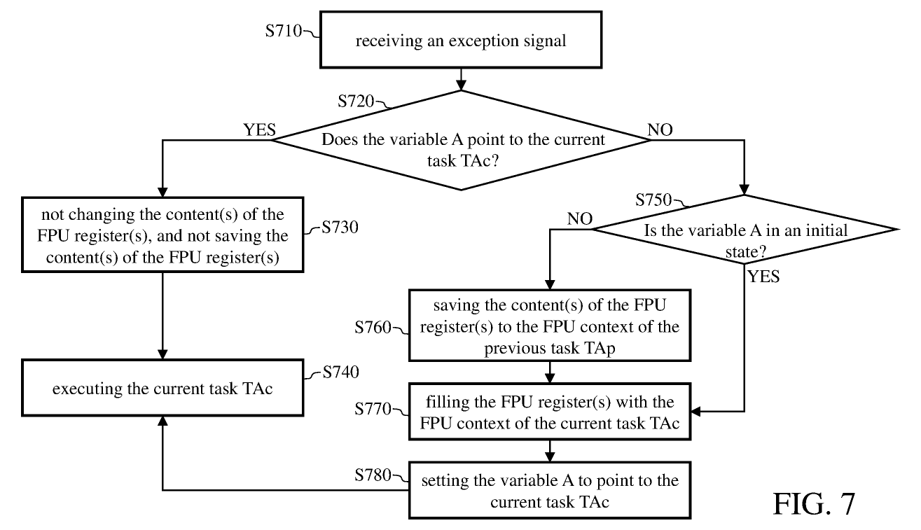

Reference is made to FIG. 6, which is a flowchart of task switch within a state according to an embodiment of the present invention. When the computing circuit 210 switches from the previous task TAp to the current task TAc, the computing circuit 210 (or the operating system it executes) performs a context switch (step S610, refers to the discussion about FIG. 5), turns off the FPU 215 (step S620), and then executes the current task TAc (step S630). When the current task TAc is to use the FPU 215, the computing circuit 210 will generate an exception signal because the FPU 215 is turned off. After the operating system captures the exception signal, the operating system executes the corresponding exception handling process. In the exception handling process, the operating system turns on the FPU 215 and, depending on the situation, performs the saving and/or restoration of FPU resources (which will be detailed below with reference to FIG. 7). When the computing circuit 210 performs a task switch again (i.e., the process in FIG. 6), the FPU 215 will be turned off again (step S620).

In some embodiments, the computing circuit 210 (or the operating system it executes) turns on or off the FPU 215 by changing the stored value of a control register.

Reference is made to FIG. 7, which is a flowchart of the FPU resource management method according to an embodiment of the present invention. In the following discussion, it is assumed that the computing circuit 210 operates in the first state 410 or the second state 420, and switches from the previous task TAp to the current task TAc. The process of FIG. 7 is a part of the operating system and includes the following steps.

Step S710: The operating system receives an exception signal, indicating that the current task TAc contains a floating-point instruction which will use the FPU 215.

Step S720: The computing circuit 210 determines whether the variable A points to the current task TAc (i.e., the task that the computing circuit 210 is currently executing). More specifically, the variable A points to the TCB 300 of a certain task or to the FPU context 340 of the TCB 300. The variable A can be stored in the memory 220. The result of step S720 being YES indicates that the current task TAc has undergone several context switches after the last use of the FPU 215, and none of the tasks that operated during the process used the FPU 215.

Step S730: The computing circuit 210 does not change the content(s) of the FPU register(s) 520, nor does it save the content(s) of the FPU register(s) 520. As discussed in the previous step, because the content(s) of the FPU register(s) 520 has/have not changed since the last use of the FPU 215, the computing circuit 210 (more specifically, the FPU 215) can at this time continue executing the floating-point instruction of the current task TAc based on the current content(s) of the FPU register(s) 520 (step S740).

Step S750: The computing circuit 210 determines whether the variable A is in an initial state. The initial state may be that the variable A is unassigned or that the variable A has a default value. When the electronic device 200 is initially powered on, the variable A is in the initial state (i.e., unassigned or equal to the default value).

When the variable A is in the initial state (step S750 being YES, indicating that the FPU 215 has not been used after the electronic device 200 is powered on), the operating system restores the FPU context 340 of the current task TAc, that is, by filling the FPU register(s) 520 with the FPU context 340 of the current task TAc (step S770). It should be noted that when the current task TAc has not used the FPU 215, the FPU context 340 of the current task TAc is the initialized FPU context.

When the variable A is not in the initial state (step S750 being NO, indicating that the FPU 215 has been used after the electronic device 200 is powered on), the operating system saves the content(s) of the FPU register(s) 520 to the FPU context 340 of the previous task TAp (step S760), and then performs step S770.

Step S780: The operating system sets the variable A to point to the current task TAc (for the purpose of indicating that the most recent task using the FPU 215 is the current task TAc) and then executes the current task TAc (step S740).

In some embodiments, the first state 410 and the second state 420 both perform FPU resource management based on the flow of FIG. 7. In an alternative embodiment, the first state 410 performs FPU resource management based on the flow of FIG. 7, while the second state 420 performs FPU resource management based on other methods (e.g., the well-known eager loading method).

Reference is made to FIG. 8, which is a flowchart of the switching between states according to an embodiment of the present invention. When the computing circuit 210 switches from the second state 420 to the first state 410, the operating system of the second state 420 controls the computing circuit 210 to enter the third state 430 (step S810), and then the monitor firmware of the third state 430 turns off the FPU 215 (step S820) before controlling the computing circuit 210 to switch to the first state 410 (step S830).

Reference is made to FIG. 9, which is a flowchart of the FPU resource management method according to another embodiment of the present invention. In this embodiment, the variable A and the variable B are stored in a shared memory of the electronic device 200 (e.g., a part of the memory 220), and are shared by the operating system of the first state 410 and the monitor firmware of the third state 430. The variable B is used to store the content(s) of the FPU register(s) 520 when the computing circuit 210 is about to switch from the second state 420 to the first state 410. The variable A points to the address of the variable B, or a task of the first state 410. In the following discussion, it is assumed that the computing circuit 210 is about to switch from the first state 410 to the second state 420, and that the operating system of the second state 420 is likely to use the FPU 215. The process of FIG. 9 is executed in the third state 430 (i.e., a part of the monitor firmware) and includes the following steps.

Step S910: The computing circuit 210 determines whether the variable A is in the initial state. Refer to the discussion about step S750.

When the variable A is in the initial state (step S910 being YES, indicating that the operating system of the first state 410 has not used the FPU 215 so far), the computing circuit 210 sets the variable A to point to the address of the variable B (e.g., a certain address in the memory 220) (step S920), fills the FPU register(s) 520 with the FPU context of the variable B (step S930), and then controls the computing circuit 210 to switch to the second state 420 (step S960). It should be noted that when the operating system of the second state 420 has not used the FPU 215, the FPU context of the variable B is the initialized FPU context.

When the variable A is not in the initial state (step S910 being NO, indicating that the FPU 215 has been used), the computing circuit 210 determines whether the variable A points to the address of the variable B (step S940).

When the variable A points to the address of the variable B (step S940 being YES, indicating that during the most recent operation of the operating system of the first state 410, none of the tasks used the FPU 215), the monitor firmware of the third state 430 controls the computing circuit 210 to switch to the second state 420 (step S960).

When the variable A does not point to the address of the variable B (step S940 being NO, indicating that a task TAx used the FPU 215 during the most recent operation of the operating system of the first state 410), the monitor firmware of the third state 430 saves the content(s) of the FPU register(s) 520 to the TCB 300 (more specifically, to the FPU context 340) of the task pointed to by the variable A (i.e., the task TAx belonging to the first state 410) (step S950). Next, after executing step S920 and step S930, the monitor firmware controls the computing circuit 210 to switch to the second state 420 (step S960).

In summary, the present invention provides a comprehensive method of managing FPU resources (i.e., the strategy for saving and/or restoring registers), ensuring that the computing circuit 210 can properly manage FPU resources both within states (corresponding to the processes in FIGS. 6-7) and between states (corresponding to the processes in FIGS. 8-9). This significantly reduces the time and space overhead for saving and/or restoring FPU resources during state switch of the computing circuit 210 that supports multi-systems, while also ensuring safety and stability. In addition, when the computing circuit 210 switches from the second state 420 to the first state 410, there is no cost incurred for saving FPU resources (only need to turn off the FPU 215, see FIG. 8). When the computing circuit 210 switches from the first state 410 to the second state 420, the frequency of saving and/or restoring the FPU resources is also much lower than that of the conventional eager loading method. Therefore, the present invention not only ensures the safety and stability before and after state transitions, but also significantly reduces the time overhead for saving and/or restoring the resource resulting from the use of the FPU by the code, making the transitions between states faster and more time-efficient.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. An electronic device, comprising:
a computing circuit, wherein the computing circuit comprises a floating-point unit (FPU), the FPU comprises an FPU register, and the computing circuit operates in one of a first state, a second state, and a third state; and
a memory configured to store a first variable and a second variable;
wherein when the computing circuit switches from the first state to the second state, and the first variable is in an initial state, the computing circuit performs following steps:
(A) setting the first variable to point to an address of the second variable; and
(B) filling the FPU register with an FPU context of the second variable.

2. The electronic device of claim 1, wherein when the first variable is not in the initial state, and the first variable does not point to the address of the second variable, the computing circuit saves a content of the FPU register to a task control block (TCB) of a task pointed to by the first variable; wherein the task belongs to the first state, and the TCB is stored in the memory.

3. The electronic device of claim 1, wherein when the computing circuit switches from the second state to the first state, the computing circuit turns off the FPU.

4. The electronic device of claim 1, wherein the computing circuit sets the first variable to point to a current task when the computing circuit operates in the first state, and the current task uses the FPU.

5. The electronic device of claim 4, wherein the FPU context is a first FPU context, the computing circuit executes a previous task before executing the current task, the computing circuit further saves a content of the FPU register to a first TCB of the previous task, and fills the FPU register with a second FPU context of a second TCB of the current task.

6. The electronic device of claim 4, wherein the computing circuit executes a previous task before executing the current task, and when the computing circuit switches from the previous task to the current task, the computing circuit turns off the FPU.

7. The electronic device of claim 1, wherein step (A) and step (B) are executed in the third state, and a third authority of the third state is higher than a first authority of the first state and a second authority of the second state.

8. A management method for a floating-point unit (FPU) resource, applied to an electronic device comprising a computing circuit and a memory that stores a first variable and a second variable, wherein the computing circuit comprises an FPU that comprises an FPU register, and the computing circuit operates in one of a first state, a second state, and a third state, the management method comprising:
(A) setting the first variable to point to an address of the second variable when the computing circuit switches from the first state to the second state, and the first variable is in an initial state;
(B) filling the FPU register with an FPU context of the second variable; and
(C) controlling the computing circuit to switch to the second state.

9. The management method of claim 8 further comprising:
(D) saving a content of the FPU register to a task control block (TCB) of a task pointed to by the first variable when the first variable is not in the initial state, and the first variable does not point to the address of the second variable;
wherein the task belongs to the first state, and the TCB is stored in the memory.

10. The management method of claim 8 further comprising:
(D) turning off the FPU when the computing circuit switches from the second state to the first state.

11. The management method of claim 8 further comprising:
(D) setting the first variable to point to a current task when the computing circuit operates in the first state, and the current task uses the FPU.

12. The management method of claim 11, wherein the FPU context is a first FPU context, the computing circuit executes a previous task before executing the current task, and the management method further comprises:
(E) saving a content of the FPU register to a first TCB of the previous task; and
(F) filling the FPU register with a second FPU context of a second TCB of the current task.

13. The management method of claim 11, wherein the computing circuit executes a previous task before executing the current task, and the management method further comprises:
(E) turning off the FPU when the computing circuit switches from the previous task to the current task.

14. The management method of claim 8, wherein step (A), step (B), and step (C) are executed in the third state, and a third authority of the third state is higher than a first authority of the first state and a second authority of the second state.

15. A management method for a floating-point unit (FPU) resource, applied to an electronic device comprising a computing circuit and a memory that stores a first variable and a second variable, wherein the computing circuit comprises an FPU that comprises an FPU register, and the computing circuit operates in one of a first state, a second state, and a third state, the management method comprising:
(A) saving a content of the FPU register to a task control block (TCB) of a task pointed to by the first variable when the first variable is not in an initial state, and the first variable does not point to an address of the second variable;
wherein the task belongs to the first state, and the TCB is stored in the memory.

16. The management method of claim 15 further comprising:
(B) turning off the FPU when the computing circuit switches from the second state to the first state.

17. The management method of claim 15 further comprising:
(B) setting the first variable to point to a current task when the computing circuit operates in the first state, and the current task uses the FPU.
